(19) United States
(12) Patent Application Publication
(10) Pub. No.: US 2004/0083874 A1
(43) Pub. Date: May 6, 2004

(54) Thumb rest for stringed instrument

(76) Inventor: Thomas Cacioppo, Haverstraw, NY (US)

Correspondence Address: OSTROLENK FABER GERB & SOFFEN, 1180 AVENUE OF THE AMERICAS, NEW YORK, NY, 100368403

(21) Appl. No.: 10/350,479

(22) Filed: Jan. 22, 2003

Related U.S. Application Data
(60) Provisional application No. 60/423,855, filed on Nov. 1, 2002.

(51) Int. Cl. G10D 3/18

(52) U.S. Cl. 84/328

(57) ABSTRACT

A thumb rest for installation in a recess formed in the body of a guitar, or the like, includes a base having a longitudinal slot oriented generally along the length of the strings, and a thumb support lever supported on a pivot shaft which is movable along the slot, whereby the thumb support lever may be moved to a desired position and angular orientation relative to the strings. A retaining nut longitudinally movable in the base threadedly engages with one end of the pivot shaft, and a locking knob at the other end of the shaft and a resilient washer located between the thumb support lever and the base allows the lever to be tightened and retained at the desired position. A shoulder extending from the base serves as template for the depth of the recess, and forms a frame to provide a neat finished appearance down over the pivotable finger support and presses the finger support against a resilient washer which is pressed against the slide. The thumb support lever is formed of two arms disposed at an angle to each other. The arm on which the thumb actually rests is slightly curved for comfort and convenient use, and may be fitted with a resilient boot. For a semi-hollow or hollow guitar, an adapter ring fits around the front plate with the shoulder recessed therein to provide better distribution of force on the relatively thin front face of the guitar. Spring clips located inside the guitar body shaped to bear against the inner surface of the guitar face cooperate with mounting screws extending through the base.

### BACKGROUND OF THE INVENTION

1. Field of the Invention

The present invention concerns an adjustable thumb rest for a stringed musical instrument, and particularly a guitar, which offers improved accommodation of the requirements of a particular player, his comfort, and his technique of playing a particular musical work, both while sitting and standing.

2. Relevant Art

The value of providing a support for the thumb of the player of a stringed musical instrument such as a guitar, and particularly a bass guitar, has been recognized, and various devices for this purpose have been proposed. Most of these, however are intended to be mounted in a fixed position on the instrument and thus cannot be adjusted after installation to accommodate varying requirements of a particular player or musical composition. Examples of such devices are shown in U.S. Pat. No. Des. 278,155; U.S. Pat. Nos. 1,017,448 and 1,785,206; and German Pat. No. 327,389.

In my earlier U.S. Pat. No. 4,739,689, there is disclosed a thumb rest which is adjustable to a range of positions, or even out of the way, with consequent improved comfort or ease in playing different types of musical compositions such as Spanish music, rock music, classical music, jazz, funky music, etc., for which different hand positions are needed.

The thumb rest of my earlier patent includes a body portion which is adhesively mounted on the face of the instrument adjacent to the strings, for example, using double-sided tape. The device also includes a curved thumb support lever designed to slide within a slot in the body portion that defines a slideway to selectable positions relative to the strings. In addition, the thumb support lever is pivotable within the slideway. A screw mechanism which cooperates with a slidable nut captive in the body portion is provided to lock the thumb support lever at a desired position in the slideway and at a desired angular orientation.

The patented device, however, has been found to posses several disadvantages. For example, the thickness and shape of the body portion was selected to make the device both economical and easy to manufacture, but also strong enough to provide the needed support. As a consequence, the thumb support lever was positioned so high relative to the plane of the strings that the player's hand was often too far from the strings for comfort and proper technique.

In addition, the curvature of the thumb support lever sometimes caused discomfort to the player, especially while standing, and sometimes impeded rapid movement of the hand to different positions along the strings.

Also, the patented device was better adapted for use with solid-bodied guitars, rather than semi-hollow or hollow guitars.

Thus, there still exists a need for an improved thumb rest for a stringed instrument such as a guitar which is more comfortable, which better accommodates the technique requirements of different types of music, and is conveniently usable with semi-hollow and hollow bodied guitars, as well as solid bodied instruments.

### SUMMARY OF THE INVENTION

The present invention seeks to meet the above-described need by providing a thumb rest for a stringed musical instrument, which is comprised of a slide having a base positionable in a milled or routed recess in a face of the instrument body and includes a groove or slot defining a slideway in the base. The thumb rest further includes a thumb support lever which is movable along the slideway track, and pivotable about an axis substantially perpendicular to the face of the instrument body, and a locking device that secures the thumb support at a desired pivot angle and position along the slideway track.

According to a first aspect of the invention, the slide base is designed to be sufficiently recessed into the instrument body that the thumb support lever lies substantially in the plane of the strings, or closer to the instrument body than the plane of the strings.

According to a second aspect of the invention, the thumb support lever includes a hub portion and an extended lever portion having a slight curvature. The lever portion may optionally be covered by a padded boot.

According to a third aspect of the invention, the slide body may include a front plate, a depending skirt that fits in the recess in the instrument body, and a shoulder at the top of the skirt to limit the depth to which the skirt can be recessed into the instrument body, and to provide a frame for the milled or routed recess.

According to a fourth aspect of the invention, the slide base may be secured in the recess by fasteners such as screws.

According to a fifth aspect of the invention, for a semi-hollow or hollow guitar, there may be provided an adapter ring designed to fit around the front plate with the shoulder recessed therein to provide better distribution of force on the relatively thin front face of the guitar.

Further according to the fifth aspect of the invention, the slide base may be secured in the recess by spring clips located inside the guitar body that are retained in place by screws passing through the slide base. When the screws are tightened, the spring clips bear against the inner surface of the guitar face to hold the thumb rest firmly and reliably in place.

According to a sixth aspect of the invention, the thumb support lever is pivotally and slidably mounted on a threaded shaft having a locking knob at one end. The shaft threadedly engages with a retaining member slidably mounted in the slide base so that tightening the knob locks the thumb support lever in a desired position. A resilient member such as a neoprene or latex washer may be provided between the thumb support lever to help hold the thumb support lever at the desired position when the knob has been tightened.

According to a seventh aspect of the invention, for a semi-hollow or hollow guitar, a snap-on cover may also be provided on the bottom of the slide base to prevent the retaining member for the threaded shaft from falling into the guitar body.

According to an eighth aspect of the invention, the thumb support lever is formed of a first arm segment which extends from a rotatably mounted hub toward the strings, and a second arm segment which extends at an angle from the first arm segment at the end thereof opposite the hub.

Accordingly, it is a primary object of the present invention to provide an improved adjustable thumb rest for use on a stringed musical instrument such as a guitar.

Another object of the invention is to provide such an improved thumb rest which is recessed into the body of the instrument so the user's hand can be positioned close to the plane of the strings.

A further object of the invention is to provide such an thumb rest which provides improved comfort for the user's thumb, and allows the thumb to be more easily moved off the thumb rest so that the position of the hand can easily be changed, especially when the player is standing.

Yet a further object of the invention is to provide a thumb rest which can be conveniently used on semi-hollow or hollow guitars, as well as on solid-bodied instruments.

Other objects and features of the present invention will become apparent from the following description of a preferred embodiment of the invention considered in conjunction with the accompanying drawings.

### BRIEF DESCRIPTION OF THE DRAWINGS

FIG. 1 is a top perspective showing a guitar on which a thumb rest according to the invention has been installed.

FIG. 2 is an exploded perspective view of the thumb rest as seen from below.

FIG. 3 is a top perspective view showing the assembled thumb rest and the installation recess in the body of a guitar.

FIG. 4 is a bottom perspective view of the assembled thumb rest.

FIG. 5 is a top plan view showing the base and the thumb support lever with the locking knob removed for clarity.

FIG. 6 is a longitudinal sectional view showing the installed thumb rest taken along line 6-6 in FIG. 1.

FIG. 7 is an enlarged view of the thumb support lever identifying certain dimensions of a preferred embodiment thereof.

FIG. 8 is a top perspective view of an adapter ring for use with semi-hollow or hollow guitars.

FIG. 9 is a cross-sectional view showing the installation of a thumb rest according to the invention attached to a hollow-bodied guitar using spring clips.

FIG. 10 is a top plan view of a snap-on retaining cover for use with semi-hollow or hollow guitars.

### DESCRIPTION OF A PREFERRED EMBODIMENT

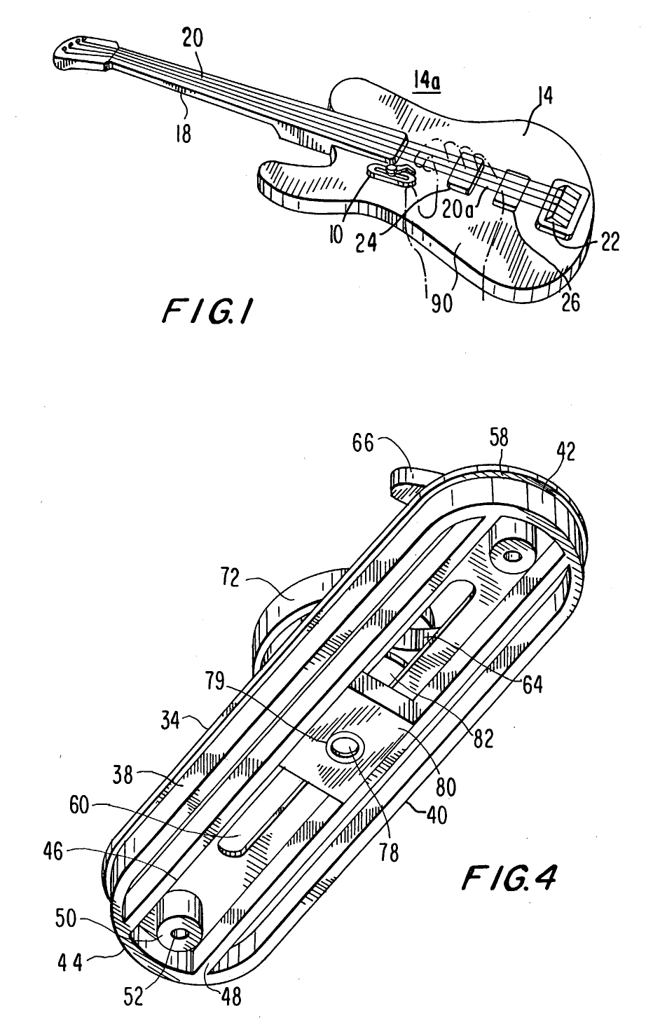

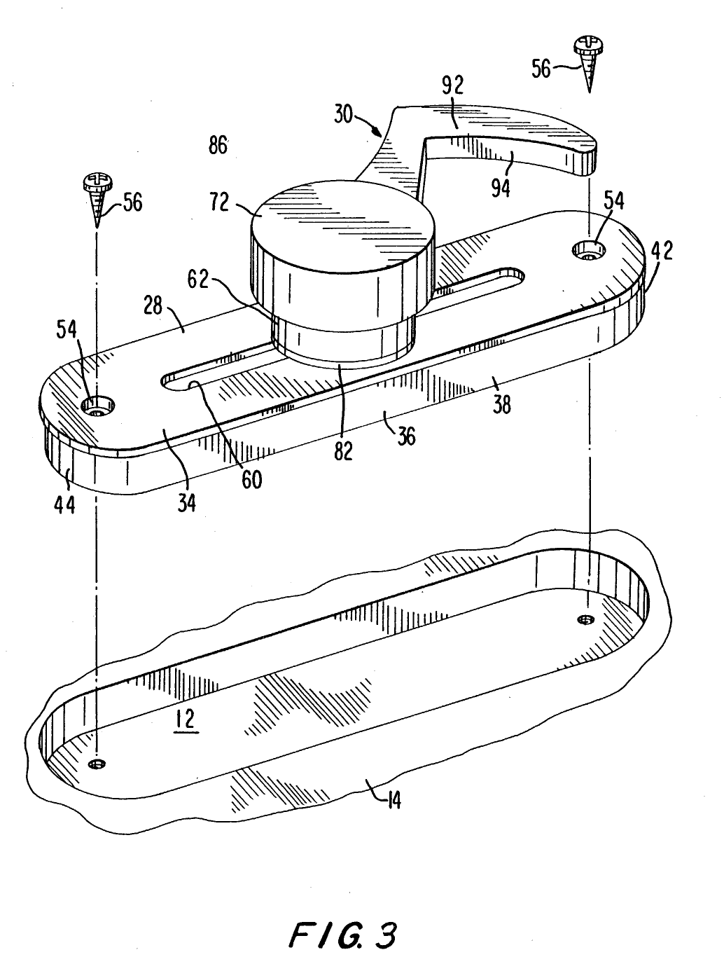

Referring to FIGS. 1 and 3, the thumb rest according to the present invention, generally denoted at 10, is installed in a recess 12 (see FIG. 3) which is milled or routed into the body 14 of a guitar 14a, which includes a neck 18 extending from the left end of the instrument (this, and other directional references herein being relative to the intended playing position), an array of strings 20 anchored in a conventional manner to machine heads at the left end of neck 18 (not shown), and to a bridge 22 at the right end of body 14, and one or more pickups 24, 26.

The invention is particularly useful in connection with a bass guitar, but may also be used to advantage with any other stringed instrument played by finger picking. Thumb rest 10 maybe installed when the instrument is assembled, or may be retrofitted.

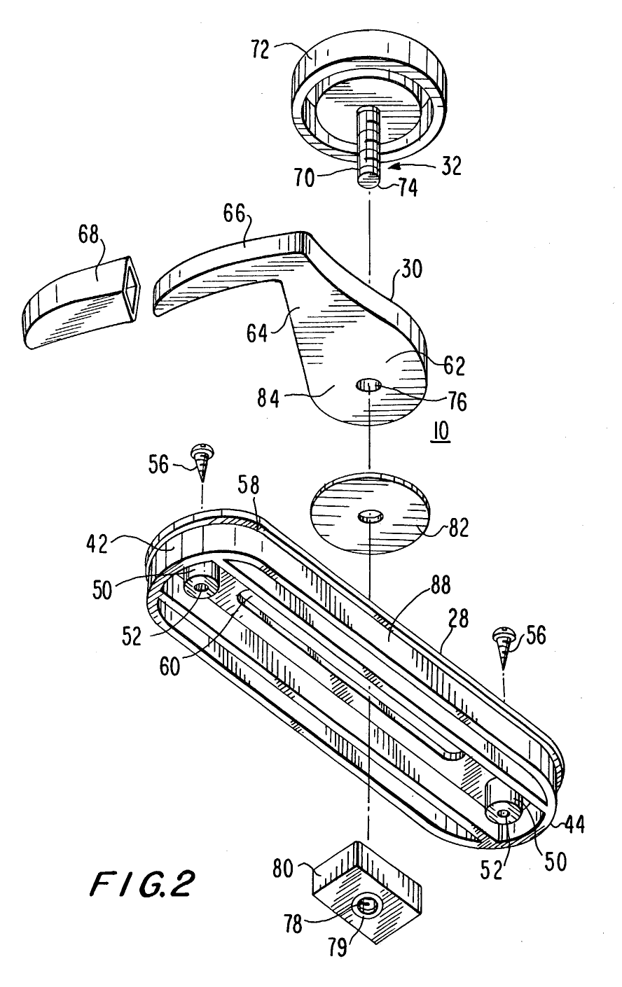

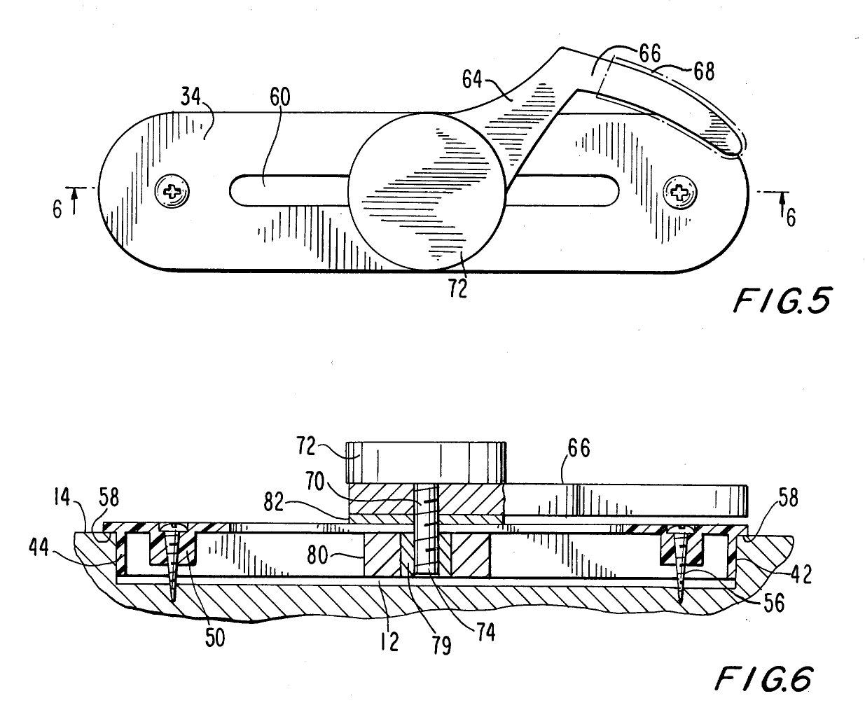

As shown in FIGS. 2-6, thumb rest 10 is comprised of a base 28, a thumb support lever 30, and a locking mechanism 32. Base 28 is preferably molded of a suitable plastic material, and includes a front plate 34 and a backwardly depending skirt 36. Skirt 36 is defined by straight parallel top and bottom portions 38 and 40, and curved, preferably semi-circular ends 42 and 44, the shape being intended to facilitate formation of recess 12 into which base 28 is installed.

Extending parallel to top and bottom portions 38 and 40 from the under side of front plate 34 are longitudinal, transversely spaced stiffening ribs 46, 48. Circular bosses 50 also extend backwardly from opposite ends of the back side of face plate 34. Axial openings 52 in bosses 50 terminate in openings 54 in front plate 34 to receive mounting screws 56 by which base 28 is secured in recess 12. For a solid-bodied instrument wood screws may be used. For a hollow-bodied instrument, machine screws may be employed, and secured by lock washers and nuts positioned within the instrument body. As illustrated, front plate 34 is slightly larger than skirt 36. Thus, the extending portion of the underside of front plate 34 defines a shoulder 58 which serves as a template for determining the minimum depth of recess 12. Shoulder 58 also serves as a marginal frame for the recess, thereby imparting a finished appearance after installation, and preventing damage to the margins of recess 12 during use.

A longitudinal slot 60 in front plate 34 extends between openings 54, and serves as a slideway for thumb support lever 30, as described below.

Thumb support lever 30 is molded or otherwise formed of a suitable plastic material or wood, and includes a central hub 62, a first arm portion 64 extending outwardly from hub 62, and an angularly depending second arm portion 66 extending from the end of first arm 64 opposite to hub 62. A padded boot 68 may be removably installed, if desired, over second arm 66.

Locking mechanism 32 is comprised of a threaded shaft 70 secured at one end to a locking knob 72. The other end 74 of shaft 70 extends through a central opening 76 in hub 62, and through slot 60 to threadedly engage with a threaded opening 78 in a retaining nut 80 movably fitted between ribs 46 in base 28.

Threaded shaft 70 and locking knob 72 may be formed in any suitable manner. For example, a hex head bolt may be molded into or otherwise firmly secured within a plastic locking knob 72. The latter may be knurled for convenient gripping, or provided with a soft cover made of rubber or the like.

Retaining nut 80 maybe formed of metal or molded of plastic with a metal insert to receive the threads of shaft 70.

Shaft 70 slides freely in slot 60, the latter thus forming a longitudinal slideway which allows longitudinal positioning of thumb support lever 30 relative to strings 20. Thumb support lever 30 is also pivotable on shaft 70 to permit adjustment of its angular position relative to strings 20. The thickness of retaining nut 80 is slightly less than the depth of skirt 36 to assure that contact between it and the bottom of recess 12 does not impede free movement of shaft 70 in slot 60. At least one face of nut 80 may be bevelled to facilitate movement along slot 60.

When tightened, locking knob 72 draws retaining nut 80 tight to lock thumb support lever 30 at the desired position. A resilient washer 82 formed of neoprene, latex or similar material, positioned between the bottom surface 84 of hub 62 and front plate 34, helps keep thumb support lever 30 locked in place.

When base 28 and thumb support lever 30 are formed by injection molding, advantage may be taken of the fact that the mold surfaces are often formed by electrical discharge machining (EDM) and the finish on the surfaces of the mold can be used to impart a slightly roughened surface to the molded part. By providing the front surface of front plate 34, and at least the back face of thumb support lever 30 with the EDM finish, better gripping for washer 82 can be achieved.

Among the considerations important to the success of the invention are the dimensions and position of base 28, and the dimensions and shape of thumb support lever 30. These allow convenient positioning of the user's thumb relative to strings 20 by sliding and rotating thumb support lever 30 without concern that the adjacent pickup will interfere with its movement. Thus, thumb support lever 30 can easily be positioned to accommodate a range of hand sizes, as well as different playing positions needed for different playing styles or types of music.

In one preferred embodiment, particularly suitable for a solid-bodied instrument, base 28 is 3.5 inches long, 1.0 inch wide, front plate 34 is 0.125 inch thick, and skirt 36 is 0.375 inch thick. Using shoulder 58 as a guide, recess 12 is made deep enough to receive skirt 36 therein with shoulder 58 resting against body 14, but may be made deeper if desired. Screw 70 may project about 0.875 inch beyond the bottom of adjusting knob 72.

Recess 12 preferably extends parallel to strings 20, and is located so the transverse center line 86 of base 28 is aligned with the left end of neck 18, and the outer face 88 of bottom skirt portion 40 is about 1.5 inches above the top string 20a (the E-string on a four-string bass guitar). However, recess 12 may be located at other positions, and at an angle to the strings if desired, so long as thumb support lever 30 clears adjacent pickup 24, and a pick guard (not shown) if installed on face 90 of the guitar.

Thumb support lever 30 is approximately 0.125 inch thick so that its outer surface 92 lies approximately in, or just below the plane of the strings 20 of most instruments. For unusual instruments, thumb support lever 30 can be made thicker or thinner, or two levers of different thickness may be supplied. Also, the thickness of washer 82 can be adjusted. Multiple washers may alternatively be employed.

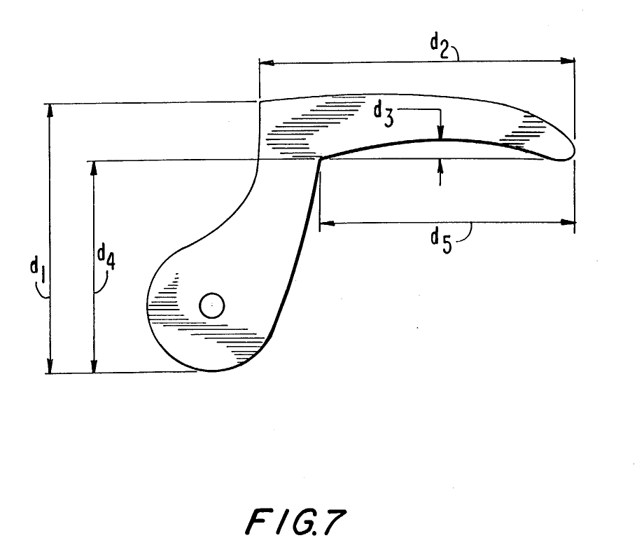

Referring to FIG. 7, for most convenient use, it is found that the length d₁ of thumb support lever arm portion 64 should be 1.875 inches, and the length d₂ of thumb support lever arm portion 66 should be 2.125 inches. The angle a between lever arms 64 and 66 should be between about 90 degrees, or somewhat greater.

The upper surface 94 of second lever arm 66 should be slightly curved for comfort of the user and for quick release of the thumb when necessary during play. In a preferred construction, surface 84 is smoothly curved to a maximum depth d₃ of about 0.25 inch. Dimensions d₄ and d₅ are respectively 1.375 inches and 1.75 inches.

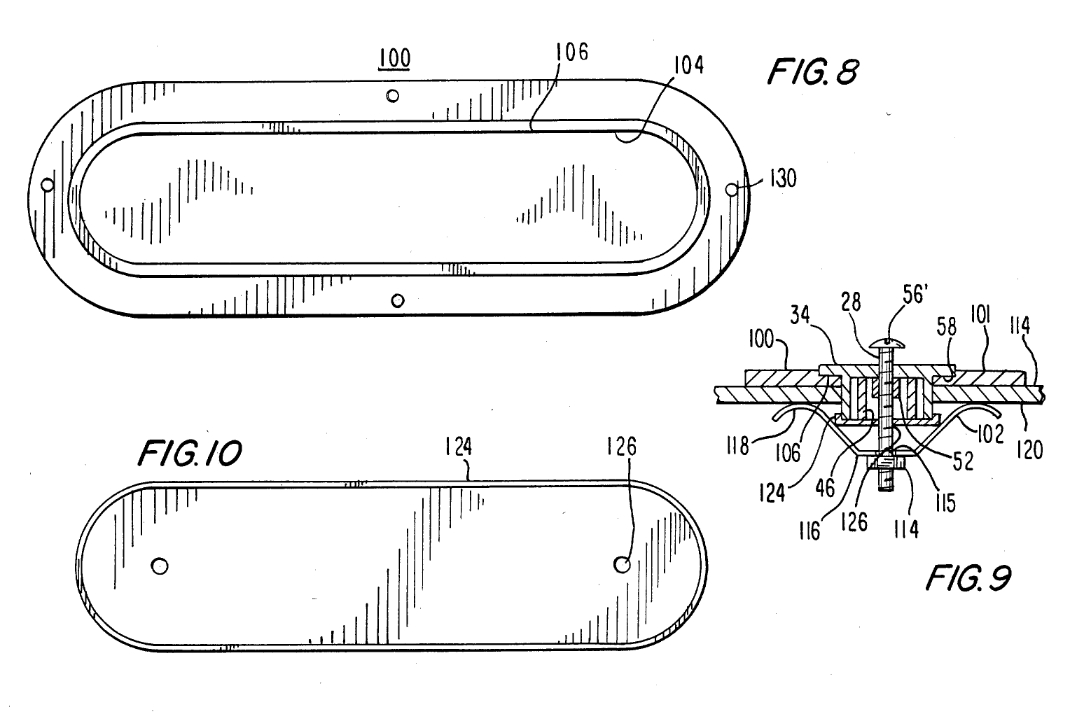

For semi-hollow or hollow guitars, the thickness of the front face of the instrument will generally be less than the depth of skirt 36, and consequently, recess 12 will be replaced by an opening through the front of guitar body 14. To secure thumb rest 10 reliably in place, and to protect the body of the guitar from damage due to concentration of forces from the mounting screws 56, and the pressure of the user's thumb on lever 30, a modified installation may be provided, as shown in FIGS. 8-10.

In the modified installation, an adapter ring 100, and spring clips 102 are employed to better distribute the forces. Adapter ring 100 is designed to fit around base 28, and to this end, has an internal opening 104 sized to receive skirt 36 of base 28, the margin of opening 104 being defined by an inwardly extending shoulder 106 recessed below its front surface 108. The depth of shoulder 106 below surface 108 is preferably equal to the depth of shoulder 58, but may be slightly shallower if desired. The width of shoulder 106is equal to the width of shoulder 58. Recess 12 in guitar body 14 is sized to receive skirt 36 as in the case of the solid body installation. It will thus be appreciated that upon assembly, adapter ring 100 is positioned against the face of guitar body 14, and shoulder 58 rests on shoulder 106 with the surface of front face 34 at or slightly above the surface 101 of adapter ring 100.

Body 28 is secured in recess 12 by two metal spring clips 102. As shown in FIG. 9, these are held in place by two mounting screws 56′ which extend through bosses 52 (see FIGS. 2 and 9) and engage with captive mounting nuts 114 aligned with openings 115 in the central portions 116 of the spring clips. Alternatively, openings 115 may be threaded to engage with screws 56′, and nuts 114 dispensed with.

As illustrated in FIG. 9, central portion 116 and outwardly extending opposed wing portions 118 are shaped and sized to receive base 28, and wing portions 118 are compressed upon assembly to bear resiliently on the inner surface 120 of the front of face of the instrument.

In the case of an installation in a solid-bodied guitar, retaining nut 80 is held captive by the bottom of recess 12. For installation in a semi-hollow or hollow-bodied guitar, however, if the threaded shaft of locking mechanism 32 is fully removed from retaining nut 80, the nut will fall into the body of the guitar. To avoid this, a bottom cover 124 as illustrated in FIGS. 9 and 10 may be provided. This fits over the bottom of body 28 and is held in place by spring clips 102. Holes 126 are aligned with bosses 52 to permit mounting screws 56′ to pass through and engage with mounting nuts 114.

Adapter ring 100 extends outwardly beyond shoulder 106 by a sufficient distance to adequately distribute the forces, for example, about 0.625 inch or more. In addition, to provide further support for spring clips 102, adapter ring 100 may be provided with four counter sunk holes 130 oppositely located at its ends and midway along its sides. These accommodate flat-head wood screws which anchor adapter ring 100 firmly against body 14.

The present invention therefore provides an improved thumb rest for the player of a stringed musical instrument, such as a guitar, which enables the player to adjust the position of the thumb rest both longitudinally and rotationally relative to the strings for convenient accommodation of hand size, required playing position and instrument configurations.

Although the present invention has been described in connection with a preferred embodiment thereof, many variations will now become apparent to those skilled in the art. It is intended, therefore, that the present invention be limited not by the specific disclosure herein, but only by the appended claims.

What is claimed is:

1. A thumb rest for a stringed musical instrument, the instrument having a body and an array of strings which extend along, and are spaced away from a face of the instrument body, the thumb rest comprising:
a base positionable in a recess formed in the face of the instrument, the base including:
a longitudinal slot defining a slideway therein; and
a thumb support, the thumb support being movable along the slideway, and pivotable about an axis substantially perpendicular to the face of the instrument body; and
a locking device that secures the thumb support at a desired pivot angle and a desired position along the slideway, whereby the thumb of a player may be supported at a desired longitudinal and angular position relative to the strings, and at a desired height relative to the plane of the strings.

2. A thumb rest according to claim 1, further including a stop member that limits the depth to which the base can be recessed into the face of the instrument.

3. A thumb rest according to claim 1, wherein the base is comprised of:
a front plate;
a skirt depending from the front plate; and
a shoulder at one end of the skirt that limits the depth to which the base can be recessed into the face of the instrument.

4. A thumb rest according to claim 1, wherein the thumb support is comprised of:
a central hub;
a first arm portion extending outwardly from the hub; and
an angularly depending second arm portion extending from an end of the first arm portion opposite the hub.

5. A thumb rest according to claim 4, wherein the surface of the second arm portion which engages with the user's thumb has a curved contour.

6. A thumb rest according to claim 4, wherein:
the hub includes a central opening;
the locking mechanism is comprised of:
a threaded member;
a locking device at one end of the threaded rod; and
a retaining element that is slidable in the base along the longitudinal slot,
the threaded member extends through the opening in the hub and through the longitudinal slot in the base and threadedly engages with the retaining element;
the threaded member is freely slidable in the slot;
the hub is pivotable on the threaded member; and
the locking device is operable to retain the hub at a selected longitudinal position and a selected angular orientation relative to the slot.

7. A thumb rest according to claim 4, further including a padded boot removably installed on the second arm portion.

8. A thumb rest according to claim 1, wherein the locking mechanism is comprised of:
a threaded member;
a locking device at one end of the threaded member; and
a retaining element that is slidable in the base along the longitudinal slot,
the threaded member extends through an opening in the thumb support and through the longitudinal slot in the base and threadedly engages with the retaining element;
the threaded member is freely slidable in the slot;
the thumb support is pivotable on the threaded member; and
the locking device is operable to retain the thumb support at a selected longitudinal position and a selected angular orientation relative to the slot.

9. A thumb rest according to claim 8, further including a resilient member positioned between the base and the thumb support.

10. A thumb rest according to claim 4, wherein the angle between the first and second arm portions is at least 90 degrees.

11. A thumb rest according to claim 1, further including:
an adapter ring which supports the base for installation on a semi-hollow or hollow-bodied instrument with the adapter ring resting on the outer surface of the face of a semi-hollow or hollow-bodied instrument;
a spring clip adapted to engage the inner surface of the face of a semi-hollow or hollow-bodied instrument; and
a fastener engageable with the base and the spring clip to secure the base in the recess.

12. A thumb rest according to claim 11, wherein:
the locking mechanism is comprised of:
a threaded member;
a locking device at one end of the threaded member; and
a retaining element that is slidable in the base along the longitudinal slot,
the threaded member extends through an opening in the thumb support and through the longitudinal slot in the base and threadedly engages with the retaining element; and
further including a cover for the back of the base that cooperates with the back of the base to hold the retaining element captive.

13. A thumb rest according to claim 12, wherein the cover is secured in place against the back of the base by the spring clip.

14. A stringed musical instrument, the instrument being comprised of:
a body;
a neck;
an array of strings extending along, and spaced away from a face of the instrument body; and the neck; and
a thumb rest, the thumb rest being comprised of:
a base positioned in a recess formed in a face of the instrument body adjacent to one of the strings;
a track formed in the base;
a thumb support, the thumb support being movable along the track, and pivotable about an axis substantially perpendicular to the face of the instrument body; and
a locking device that secures the thumb support at a desired pivot angle and a desired position along the slideway track, whereby the thumb of a player may be supported at a desired position relative to the array of strings.

15. A stringed instrument according to claim 14, further including a stop member which limits the depth to which the base can be recessed into the face of the instrument.

16. A stringed instrument according to claim 14, wherein the base is comprised of:
a front plate the front plate having a longitudinal slot that forms the track;
a depending skirt that fits into the recess; and
a shoulder at one end of the skirt that limits the depth of the skirt in the recess.

17. A stringed instrument according to claim 14, wherein:
the thumb support is comprised of:
a central hub pivotally mounted on a threaded member that extends through a longitudinal slot in the base that defines the track;
a first arm portion extending from the hub; and
a second arm portion extending at an angle from an end of the first arm portion opposite the hub; and
the locking mechanism is comprised of:
a locking device at one end of the threaded member; and
a retaining element that is slidable in the base along the longitudinal slot, and threadedly engages with the end of the threaded member opposite the locking device; and
the locking device, the threaded member, and the retaining device cooperate to retain the hub at a selected longitudinal position and a selected angular orientation relative to the slot.

18. A stringed instrument according to claim 17, wherein the angle between the first and second arm portions is at least 90 degrees.

19. A stringed instrument according to claim 14, wherein the thickness of the retaining device is less than the depth of skirt in the recess.

20. A stringed instrument according to claim 14, wherein the shoulder rests against the face of the instrument.

21. A stringed instrument according to claim 14, wherein the recess extends parallel to strings.

22. A stringed instrument according to claim 21, wherein the recess is located so the base is positioned with a transverse center line thereof aligned with an end of the neck.

23. A stringed instrument according to claim 14, wherein an outer face of the thumb support lies approximately in, or just below the plane of the strings.

24. An instrument according to claim 14, further including:
an adapter ring which supports the base for installation on a semi-hollow or hollow-bodied instrument with the adapter ring resting on the outer surface of the face of the instrument;
a spring clip adapted to engage the inner surface of the face of the instrument; and
a fastener engageable with the base and the spring clip to secure the base in the recess.

25. An instrument according to claim 14, wherein:
the locking mechanism is comprised of:
a threaded member;
a locking device at one end of the threaded member; and
a retaining element that is slidable in the base along the longitudinal slot,
the threaded member extends through an opening in the thumb support and through the longitudinal slot in the base and threadedly engages with the retaining element; and
further including a cover for the back of the base that cooperates with the back of the base to hold the retaining element captive.

26. An instrument according to claim 25, wherein the cover is secured in place against the back of the base by the spring clip.
